(19) United States
(12) Patent Application Publication
(10) Pub. No.: US 2008/0209062 A1
(43) Pub. Date: Aug. 28, 2008

(54) System and method for augmenting real-time information delivery with local content

(75) Inventor: Tim Barrett, Kanata (CA)

Correspondence Address: KRAMER & AMADO, P.C., 1725 DUKE STREET, SUITE 240, ALEXANDRIA, VA, 22314, US

(73) Assignee: ALCATEL-LUCENT, Paris (FR)

(21) Appl. No.: 11/710,402

(22) Filed: Feb. 26, 2007

(51) Int. Cl. G06F 15/16

(52) U.S. Cl. 709/231

(57) ABSTRACT

A method of delivering video on demand content, including selecting a video on demand asset, determining a portion of the asset that is stored on a storage media local to a client, playing the portion of the asset that is stored on the storage media local to the client from the local storage media, determining a portion of the asset that is not stored on a storage media local to the client, and playing the portion of the asset that is not stored on the storage medial local to the client off a remote server via unicast in combination with the playing the portion of the asset that is stored on the storage media local to the client.

### BACKGROUND OF THE INVENTION

1. Field of the Invention

This invention relates generally to networks and mechanisms for augmenting real-time information delivery with content stored locally.

2. Description of Related Art

One example of information delivered in real-time is Video on Demand (VoD) Content. Digital video recorders (DVRs) enable the scheduling of the recording of a video programming enabling users to view a program at the convenience of the viewer. A DVR is different from traditional video on demand as according to traditional video on demand, a user is able to instantaneously watch a program from among a wide selection of programming content, and to have the program delivered in real time across a network. Some technologies deliver broadcast content ahead of time to client devices that have storage, and then provide a user interface to allow the stored content to be watched at the convenience of the user or “on demand.”

### SUMMARY OF THE INVENTION

In light of the present need for a system and method for augmenting real-time information delivery with local content, a brief summary of various exemplary embodiments is presented. Some simplifications and omission may be made in the following summary, which is intended to highlight and introduce some aspects of various exemplary embodiments, but not intended to limit the scope of the invention.

In various exemplary embodiments, two technologies are merged to provide users with the advantages of a full Video On Demand service that is augmented by a low cost media delivery mechanism. Some information delivery systems (such as Video Delivery) require that content is delivered in real time either by way of a unicast or multicast manner. In various exemplary embodiments, content that has been pre-cached at the client device (via multicast or unicast) is used to augment a real time, on demand, video service.

Thus, in various exemplary embodiments, the load on a network for video on demand is minimized. Likewise, in various exemplary embodiments, a load on a server for video on demand is minimized. It is believed that the point to point nature of video on demand services places a large strain on a network. It is correspondingly believed that there are serious cost implications in delivering video on demand in a scaled manner via an IP network. It is believed that there are likely to be an extremely high density of set tops with built in storage, or homes with said devices. Such implementations typically include multicast capability. It is believed that the top twenty video on demand titles typically account for over ninety percent of consumer demand for video on demand services at any given point in time. Thus, it is believed that substantial savings can be realized on network and server infrastructure cost.

In various exemplary embodiments, there are mechanisms to broadly determine popular content, and there are mechanisms to deliver that content to client devices as described above. In various exemplary embodiments, after the content is delivered to the client device, when an end user selects a particular piece of Video On Demand Content, the client device determines whether any or all of that content resides locally on the client device, and if so, plays the content from the local device rather than from the network. In the case where there is missing information on the local device, this may be filled in from the network servers. Thus, in various exemplary embodiments, the client has knowledge of what information (and portions of information) are available locally, and which are not.

### BRIEF DESCRIPTION OF THE DRAWINGS

In order to better understand various exemplary embodiments, reference is made to the accompanying drawings, wherein:

FIG. 1 is a schematic diagram of a first exemplary embodiment of a video on demand delivery system;

FIG. 2 is a schematic diagram of a second exemplary embodiment of a video on demand delivery system;

FIG. 3 is a schematic diagram of a first exemplary embodiment of a method of providing video on demand; and

FIG. 4 is a schematic diagram of a second exemplary embodiment of a method of providing video on demand.

### DETAILED DESCRIPTION OF THE PREFERRED EMBODIMENTS OF THE INVENTION

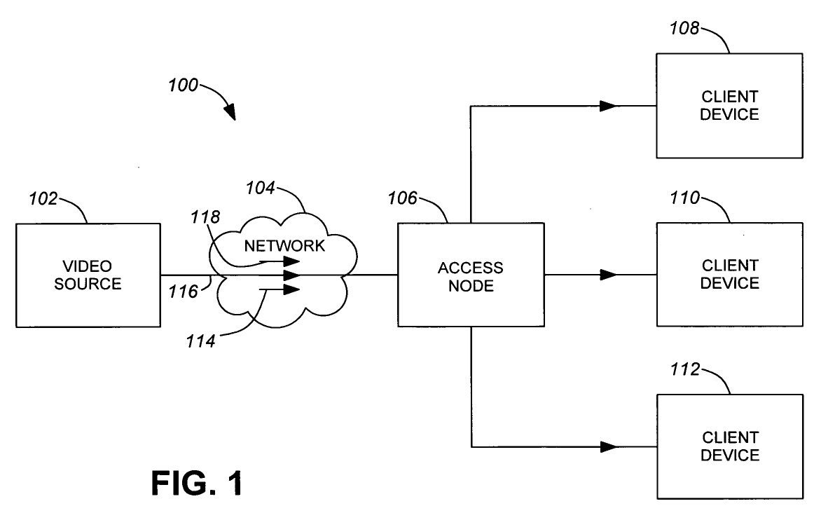

Referring now to the drawings, in which like numerals refer to like components or steps, there are disclosed broad aspects of various exemplary embodiments. It should be apparent that various aspects disclosed in various figures can be combined such that various exemplary embodiments include aspects depicted in more than one of FIGS. 1-4.

MVOD is an abbreviation of “Multicast Video On Demand” and is a concept whereby content is multicast in a non-real time fashion across a network to a PC, set top box or other device with storage. The following description focuses on various exemplary embodiments where MVOD (or similar concepts which may include real time multicast or unicast) are used to augment a live service.

In various exemplary embodiments, once the content is available on the device, a user is notified of its availability and the content is played from the device just as if it were a network based video on demand service.

While some embodiments are focused on delivery of video, other embodiments are used for any sort of data, including music, images or bulk file distribution.

In the case of video, in various exemplary embodiments, content is delivered to the clients in an encrypted form using a digital rights/conditional access scheme. In various exemplary embodiments, when the user plays the content, the client connects to the network, gets a decrypt key, bills the customer and plays the content.

Forward Error Correction and sending content multiple times in carousels may be useful to give clients multiple opportunities to receive the content completely intact and error free. Thus, in various exemplary embodiments, the MVOD client application continues to listen for streams if it has only partially received that particular stream before. This improves error correction possibilities on lossy networks.

In various exemplary embodiments, MVOD frees up significant bandwidth in the network by ensuring that the vast majority of the load that would be required by a traditional VoD service is covered instead by a single, low data rate multicast stream. In various exemplary embodiments, this then frees up some capacity that means that a larger amount of bandwidth is available for a traditional video on demand service which is being augmented by the locally stored data.

With specific reference to the figures, it should be apparent that various aspects of the various exemplary embodiments described herein are combined according to a multitude of combinations in various exemplary embodiments.

FIG. 1 is a schematic diagram of a first exemplary embodiment of a video on demand delivery system 100. The exemplary video on demand delivery system 100 includes a video source 102, a network 104, an access node 106, and client devices 108, 110, 112. In VoD delivery system 100, video data is individually delivered to each client device 108, 110, 112 from video source 102 by way of network 104 and access node 106.

In various exemplary embodiments, a separate copy of data is sent to each client 108, 110, 112 by way of the network 104. In various exemplary embodiments, separate video streams 114, 116, 118 are delivered from a video server that is included in video source 102 to each client device 108, 110, 112 individually. It is believed that such embodiments require a substantial amount of bandwidth from the network 104.

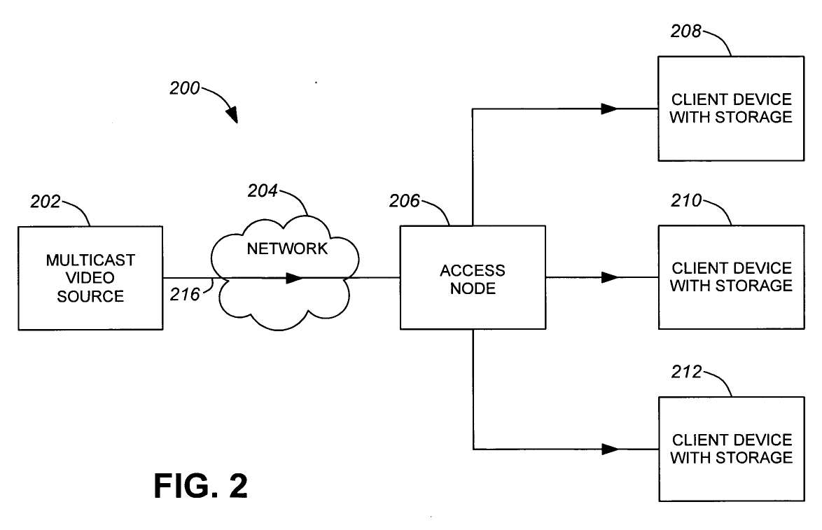

FIG. 2 is a schematic diagram of a second embodiment of a VoD delivery system 200. Exemplary VoD delivery system 200 includes a multicast video source 202, a network 204, an access node 206, and client devices with storage 208, 210, 212. Exemplary VoD delivery system 200 is a system wherein multicast content is delivered.

In various exemplary embodiments the same data is delivered to each client device with storage 208, 210, 212. In various exemplary embodiments, a single video stream 216 passes through the network 204. In various exemplary embodiments, the single video stream 216 is replicated at the access node 206 and subsequently delivered to each client device with storage 208, 210, 212.

In exemplary VoD delivery system 200, video is multicast out in non-real time. In other exemplary embodiments, video is transmitted in other manners, including real time. In various exemplary embodiments, only one copy of the video stream 216 is necessary within the network 204. In various exemplary embodiments, as depicted in FIG. 2, the client devices 208, 210, 212 include storage. In various exemplary embodiments, the client devices 108, 110, 112 are substituted for the client devices with storage 208, 210, 212.

In various exemplary embodiments including client devices with storage 208, 210, 212, when a video title is played at the client device 208, 210, 212, the video title is accessed from a local disk. In other exemplary embodiments, the video title is accessed across the network 204 when the video title is played. In various exemplary embodiments, the video title or other information is played with a combination of both local and remote content. The exemplary embodiment of VoD delivery system 200 typically reduces the bandwidth used in the network 204 as compared to the network 104.

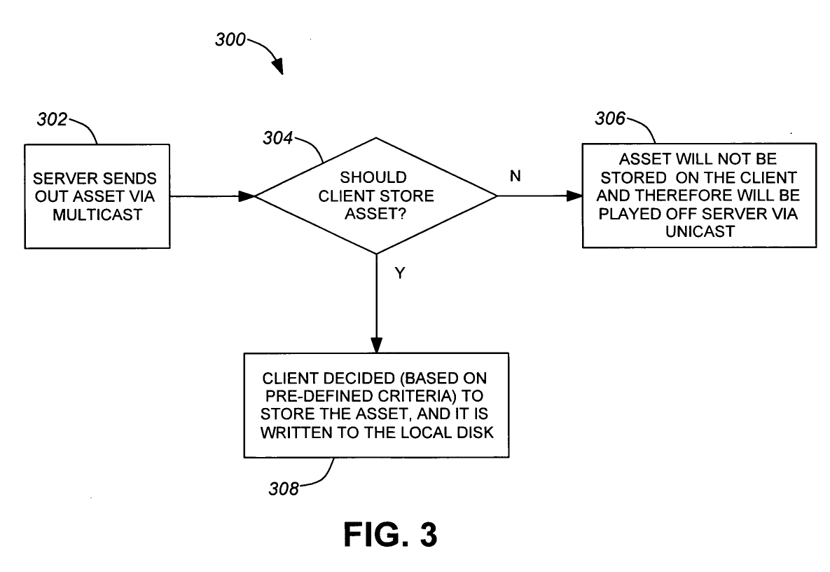

FIG. 3 is a schematic diagram of a first exemplary embodiment of a method of providing VoD 300. Exemplary method 300 begins in step 302, where a server sends out an asset (typically via multicast, but in other manners in other exemplary embodiments) and the asset is stored on many client devices. In various exemplary embodiments, the asset is received by a client device such as client devices with storage 208, 210, 212. Exemplary method 300 then proceeds to exemplary step 304.

In exemplary step 304 a determination is made whether the client device should store the asset. If a determination is made in exemplary step 304 that the client should not store the asset, then exemplary method 300 then proceeds to exemplary step 306.

In exemplary step 306, the asset is not stored locally and, if selected by a user to be played, the asset is played off the server via unicast. Because a decision was made in step 304 not to store the asset when proceeding to step 306, consequently, the asset is not stored on the client when proceeding to step 306.

When a determination is made in exemplary step 304 that the client should store the asset, exemplary method 300 proceeds to exemplary step 308. In exemplary step 308, the asset is written to the local disk. Again, exemplary step 308 is reached in exemplary method 300 when the client decides to store the asset. In various exemplary embodiments, the client decides to store the asset based on one or more pre-defined criteria.

In various exemplary embodiments, a forward error correction technology is implemented in connection with exemplary method 300. In various exemplary embodiments, an error recovery technology is implemented in connection with exemplary method 300.

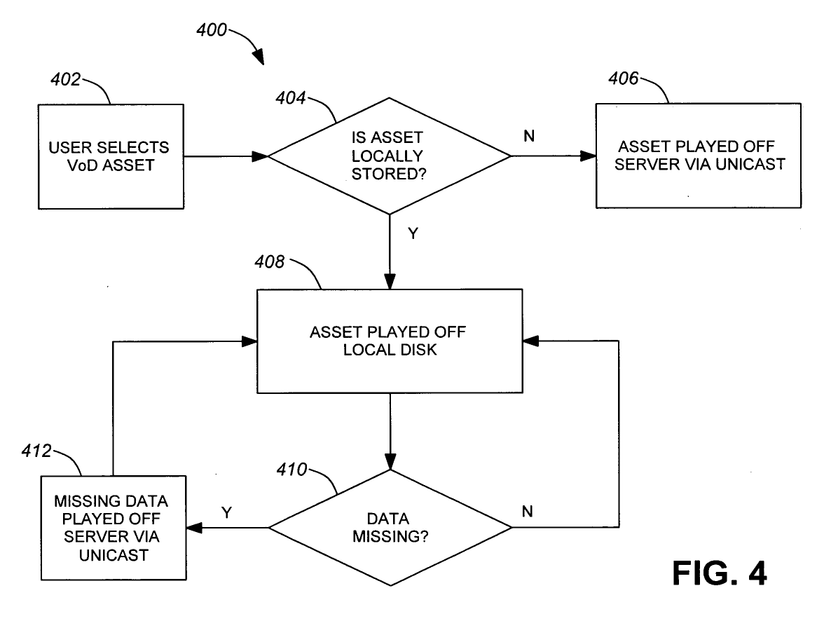

FIG. 4 is a schematic diagram of a second exemplary embodiment of a method of providing VoD 400. Exemplary method 400 begins in step 402 where a user selects a VoD asset. After a user selects a VoD asset in exemplary step 402, exemplary method 400 proceeds to step 404. In exemplary step 404, a determination is made whether the asset is stored locally. If a determination is made in exemplary step 404 that the asset is not stored locally, exemplary method 400 proceeds to exemplary step 406. In exemplary step 406, the asset is played off the server via unicast.

If a determination is made in exemplary step 404 that the asset is stored locally, exemplary method 400 proceeds to exemplary step 408. In exemplary step 408, the asset is played off the local disk. Exemplary method 400 then proceeds to exemplary step 410.

In exemplary step 410, an evaluation is performed whether data is missing from the asset stored on the local disk. When the result of the evaluation performed in exemplary step 410 is a determination that data is not missing from the asset stored on the local disk, exemplary method 400 returns to exemplary step 408 where the asset continues to play off the local disk.

If a determination is made in exemplary step 410 that data is missing from the asset stored on the local disk, exemplary method 400 proceeds to exemplary step 412. In exemplary step 412, the data determined to be missing from the asset stored on the local disk in exemplary step 410 is played off the server via unicast.

Exemplary method 400 then returns to exemplary step 408 where the asset continues to play off the local disk until the asset has been fully played at which point exemplary method 400 ends.

According to the foregoing, a client makes a determination whether data is stored on the local disk and plays all data stored on the local disk rather than retrieving that data from the network in real time. Thus, according to exemplary method 400, any portion of a title that is available on the local disk results in a savings of network bandwidth because that portion of the title need not be communicated in real time across the network.

In the foregoing manner, in various exemplary embodiments, the client keeps track of which data it has received and which data it has not received. In various exemplary embodiments, the client identifies a file that has not been completely received. In various exemplary embodiments, an information stream indicates that the title is being resent. In various exemplary embodiments, the client re-subscribes to the title until it has received all the data without error from a data stream pertaining to that title. In various exemplary embodiments, the client disconnects from the data stream of that title as soon as a determination is made that the file is complete, even if the stream for that title is otherwise continuing.

According to the foregoing, in various exemplary embodiments, in order to scale the distribution of content, the delivery mechanism is performed via a FEC protected multicast stream or streams. In various exemplary embodiments, FEC protected multicast streams are delivered at a rate completely decoupled from the data transfer rate for the content. In various exemplary embodiments, the FEC protected multicast stream is delivered at a rate according to a network requirement or requirements either faster or slower than the data rate of the content.

In various exemplary embodiments, each packet of data is tagged with a unique sequential identifier. In various exemplary embodiments, the receiver of the content is notified in advance of the characteristics of the content stream being sent. Thus, in various exemplary embodiments, the receiver of the content knows in advance when there are holes in the information being transferred. In various exemplary embodiments, one or more packets of content not included is recovered as described above alternatively, or as a supplement to, the foregoing. In various exemplary embodiments, a unicast mechanism is employed as a mechanism to request lost portions of the data steam.

According to the foregoing, in various exemplary embodiments, the load on the network is reduced. Thus, various exemplary embodiments resulting cost savings. Various exemplary embodiments improve the number of end points. Various exemplary embodiments are efficient for distributing content to VoD servers in a network. Likewise, various exemplary embodiments are effective mechanisms to reduce bandwidth requirements for delivering popular content to clients.

According to the foregoing, in various exemplary embodiments including IPTV client devices with hard disks installed, popular movies are stored on the hard disks. In various exemplary embodiments, when a user elects to play a movie, the client first checks to see if the movie title is available on local hard disks. In various exemplary embodiments, when a movie title is available on a local hard disk the desired title is played directly from the hard disk instead of by streaming the title through the network.

In various exemplary embodiments, the application and system looks ahead into the client buffer and determines what packets are missing. In various exemplary embodiments, only the missing packets are requested from the VoD server in the network. Various exemplary embodiments use a trickle down mechanism to pre-cache the starts of movies such as introductory studio content included at the beginning of a movie title. Thus, in various exemplary embodiments, a VoD title is able to start instantly and pre-fill the buffer on the set top box.

Although the various exemplary embodiments have been described in detail with particular reference to certain exemplary aspects thereof, it should be understood that other embodiments exist including combinations of various aspects described in connection with different embodiments or figures, and the details are capable of modifications in various obvious respects. As is readily apparent to those skilled in the art, variations and modifications can be affected while remaining within the spirit and scope of the disclosure. Accordingly, the foregoing disclosure, description, and figures are for illustrative purposes only, and do not in any way limit the invention, which is defined only by the claims.

What is claimed is:

1. A method of delivering data such as video on demand content, comprising:
selecting a video on demand or piece of information that would normally be delivered to a client in real time;
determining a portion of the asset that is stored on a storage media local to a client;
using the portion of the asset that is stored on the storage media local to the client from the local storage media;
determining a portion of the asset that is not stored on a storage media local to the client; and
using the portion of the asset that is not stored on the storage medial local to the client off a server via unicast in combination with the playing the portion of the asset that is stored on the storage media local to the client.

2. The method of delivering data as claimed in claim 1, further comprising sending an asset from a central server to the client.

3. The method of delivering data as claimed in claim 2, further comprising determining whether the client should store the asset.

4. The method of delivering data as claimed in claim 3, further comprising storing the asset on the client.

5. The method of delivering data as claimed in claim 4, further comprising storing the asset on the storage media local to the client.

6. The method of delivering data as claimed in claim 3, wherein said determining is based on a pre-defined criteria.

7. The method of delivering data as claimed in claim 6, wherein the pre-defined criteria is a movie genre.

8. The method of delivering data as claimed in claim 1, wherein a forward error correction technology is implemented.

9. The method of delivering data as claimed in claim 1, wherein an error recovery technology is implemented.

10. The method of delivering data as claimed in claim 1, further comprising
receiving data to be stored locally, the data having one or more portions that are received error free and one or more portions that are received with one or more errors, and
retaining information as to the one or more portions of the data that are received error free, and the one or more portions of the data that are received with one or more errors.

11. A mechanism by which a device playing back an asset can seamlessly combine data from a local source and from a source in a network according to whether the information is available locally or not.
